(19) United States
(12) Patent Application Publication
(10) Pub. No.: US 2015/0230415 A1
(43) Pub. Date: Aug. 20, 2015

(54) METHODS FOR DECREASING LOCAL TEMPERATURE USING HIGH ALBEDO MATERIALS

(71) Applicant: Leslie A Field, Portola Valley, CA (US)

(72) Inventor: Leslie A Field, Portola Valley, CA (US)

(21) Appl. No.: 14/698,779

(22) Filed: Apr. 28, 2015

Related U.S. Application Data
(63) Continuation of application No. 12/680,968, filed on Oct. 19, 2011.
(60) Provisional application No. 60/998,404, filed on Oct. 9, 2007.
(60) Provisional application No. 61/044,453, filed on Apr. 11, 2008.

(51) Int. Cl. A01G 15/00; E02B 3/00; E02B 1/00

(52) U.S. Cl. CPC A01G 15/00; E02B 1/00; E02B 3/00; E02B 2201/00

(57) ABSTRACT

A method for modifying environmental conditions comprises deploying a material having an albedo of at least 0.15 over a surface of a body of water associated with a man-made structure. The deployed material increases an albedo of the surface, increases an evaporation rate at the surface for a given temperature, and decreases a temperature characterizing the man-made structure.

### CROSS-REFERENCE

This application is a continuation of U.S. patent application Ser. No. 12,680,968, entitled METHODS FOR ENVIRONMENTAL MODIFICATION WITH CLIMATE CONTROL MATERIALS AND COVERINGS, filed on Oct. 19, 2011, which is a national stage application of PCT/US08/11690 (WO 2009/048628) filed Oct. 9, 2008, which claims priority to U.S. Provisional Application No. 60/998,404, filed Oct. 9, 2007, and U.S. Provisional No. 61/044,453, filed Apr. 11, 2008, all of which applications are incorporated herein by reference in their entirety, as if set forth in full in this application for all purposes.

### FIELD OF THE INVENTION

This invention is directed to systems, materials, and methods of environmental modification with climate control materials and coverings. The invention may include materials which may cause a localized change in albedo and evaporation rate. In addition, the invention may be reversible and may include different materials, designs, deployments, and sensing apparatus and techniques.

### BACKGROUND OF THE INVENTION

The international scientific community has reached consensus that ongoing climate change has raised the earth's global average temperature, has had an effect on the earth's ecosystems, and that larger impacts are likely in the future (IPCC AR4 2007). Current and future effects may include an increase in sea level, a reduction in the percentage of the earth's surface covered by the polar ice caps, changes in rainfall distribution and increases in the severity of storms. These changes may in future lead to effects on the oceanic currents and further changes in weather patterns, that could in turn lead to effects as diverse and profound as changes in the distribution of habitable land areas for various species, as well as in the distribution of areas suited to agriculture, and changes in locations of usable coastal ports and shipping routes. A positive feedback loop known as the Ice-Albedo Feedback Effect is involved in the reduction of icecap area, whereby the more the ice melts, the faster the remaining ice melts. This occurs because for a given area, the open ocean absorbs more solar energy (has a lower albedo) than does ice.

Weather patterns may be shifting as a result of climate change. Such changes may include changes in droughts, tropical storm strength and intensity, ocean currents, and wildfires.

Various solutions and geoengineering approaches to mitigate to some climate change effects have been proposed. The most commonly proposed long-term solution is to slow down the effects of global warming by addressing one apparent cause of global warming via a reduction in the generation of anthropogenic greenhouse gases such as carbon dioxide (CO2). The international scientific community agrees that the concentration of CO2 in the atmosphere has increased as a result of human activity and that this has caused an increase of the earth's global average temperature over the past several decades (IPCC AR4 2007).

Many proposals for reduction of the generation of greenhouse gases include proposals to reduce the rate of CO2 generation. For example, CO2 generation may be slowed down by providing for energy and transportation needs through the use of alternative power generation such as solar, wind, hydroelectric and nuclear power, and the use of alternative transportation fuels, such as electricity and various forms of bio-derived liquid fuels. These proposals and others like them are likely an important part of the long-term solution to reducing a man-made increase in CO2, but they could take decades to implement widely, and there are substantial technological, sociological, political and economic hurdles to be overcome before widespread adoption is likely to occur.

Another type of proposed solution is aimed at conducting geoengineering directed toward mitigating some of the effects of global warming. One example of such a proposal is the addition of specific gases to the atmosphere to produce an “anti-greenhouse” effect. Some sulfur-containing industrial pollutants have been shown to have a negative greenhouse effect, leading this idea's proponents to advocate a deliberate increase in these pollutants.

Another proposal to reduce the effects of global warming is to use orbiting solar reflectors. For example, it is proposed that trillions of mirrors be sent up into earth orbit to reflect some percentage of incoming sunshine.

Some parties have suggested carbon sequestration to reduce global warming. Various plans include burying carbon compounds in the ground, and seeding the oceans with iron to increase phytoplankton colonies, with the hope that as the plankton die, the carbon they've incorporated will sink to the ocean bottom.

In another proposal, floating plastic islands may be used to limit global warming. The idea includes covering part of the ocean with a material that has reduced absorption of solar energy and has a higher albedo.

Some difficulties with the methods listed above include their cost, irreversibility (for instance, if the solution overcorrects), the massive public works nature of the solutions, unintended weapons potential, and possible severe secondary problems (such as acid rain or health effects from added atmospheric sulfur compounds). Some negative effects of these proposals may include uncontrolled change in oceanic evaporation rate and change to the local ecosystem, ecological effects (such as a change in the plankton species selection), and unintended reverses of the solutions (such as sudden release of CO2 from sequestration schemes). It is thought this could occur if the temperature of the earth (and/or ocean) increases sufficiently over time to cause a release of sequestered CO2.

There is a need for improved systems and methods of environmental modification that may be applied locally and that may be fully reversible or may be used to correct environmental effects in the opposite direction until the desired stabilization is achieved.

### SUMMARY OF THE INVENTION

This invention provides systems and methods of environmental modification with climate control materials and coverings by causing a local adjustment of two parameters that may affect the local climate. The invention may affect (1) the absorption and/or reflection of incident solar energy (albedo), and (2) the rate and amount of evaporation of water. The invention may also contain buoyancy or added floating features, which may aid in the invention's effectiveness. The invention may also be designed to minimize ecological harm. It may also enhance ice nucleation, provide habitat and breeding ground, and intentionally provide open pore-like areas to enhance cooling by evaporative heat transfer.

The invention may include using materials capable of affecting the local environment by having the desired albedo and desired characteristics to affect evaporation, which may affect overall local albedo and evaporation rate. These materials may have varying properties, such as optical properties, wettability, porosity, buoyancy, thermal conductivity, imperviousness, strength, breakability characteristics, and may include or be made from recycled or biodegradable materials. Climate control materials may have different designs or forms which may affect or enhance the effects of material properties. Pores or surfaces of the materials may provide an increased surface area over which evaporation may occur. Controlling or changing these material properties may result in affecting local albedo and evaporation, which may result in environmental modification.

There may be various methods of manufacturing or assembling the climate control materials. These methods may provide efficient or cost-saving means of producing the climate control materials.

Another aspect of the invention may provide for deployment of the climate control materials and coverings. The climate control materials and coverings may be deployed in different locations and environments for various applications, and may be deployed by different means. The climate control materials may also be reversible. A party may be able to remove the materials, may deploy additional materials with reversing effects, or the materials themselves may eventually self-remove or self-reverse. For example, materials may self-remove or self-reverse by breaking down or sinking, or from changes in their characteristics from eventual biofouling from the surrounding environment.

The climate control materials may also have sensors, communication, or power devices deployed near or on them in different manners. These sensors may provide feedback on desired characteristics of the materials and their environmental and ecological impact. The sensors may also provide for control applications.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates one embodiment of the invention, which may incorporate a floating material that may reflect sunlight and enhance water evaporation.

FIG. 1B illustrates an example of a heat transfer model.

FIG. 2 illustrates how the materials may also be deployed by unrolling.

FIG. 3 shows how materials may be corralled into a unit.

FIG. 4 shows one example of a closely packed building cluster for floatable climate control materials.

FIG. 5A shows one example of a building cluster for floatable climate control materials comprising building blocks made up of plates.

FIG. 5B shows how building blocks may be corralled to control location.

FIG. 6A shows an embodiment of the invention where the building blocks may be corralled but so that they are closely packed.

FIG. 6B shows an alternate embodiment of the invention where the building blocks may be corralled but in a looser arrangement so that they there may be more open areas.

FIG. 7 shows one embodiment of the invention where corralled building blocks may be distributed individually.

FIG. 8 shows an example of a pullout.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

This invention provides systems and methods of environmental modification with climate control materials and coverings by causing a local adjustment of two parameters that may affect the local climate. The invention may affect (1) the absorption and/or reflection of incident solar energy (albedo), and (2) the rate and amount of evaporation of water. Added buoyancy or floating features of the invention may aid in the invention's effectiveness. Having pores or various surface designs of the invention may provide increased or decreased surface area, which may affect the evaporation rate of surrounding water. The invention may also be designed to minimize ecological harm. As an example of potential ecological harm, materials such as plastic used over wide areas, such as in the floating plastic island proposal of the prior art or the unintentional pollution of the Pacific Gyre with plastic waste, can result in the plastic breaking down over time into smaller pieces and enter the food chain directly, and such materials can also carry other pollutants into the food chain on due to a plastic surface's general affinity for hydrocarbon- and oil-based pollutants. The invention may also enhance ice nucleation, provide habitat and breeding ground, and intentionally provide open pore-like areas to enhance cooling by evaporative heat transfer and by providing an increased effective surface area.

The albedo of areas may be adjusted in order to slow down the melting rate, enhance retention, and/or increase the formation of ice and/or snow. The albedo of areas may also be adjusted to provide general cooling effects, even in areas and seasons where ice is not formed. This may include adjusting the albedo to increase the reflection of sunlight. For example, this may involve increasing the albedo of an area above the albedo of open seawater, to at least 0.15. This may also include increasing the albedo further to a level greater than the global average of the earth, or to at least 0.35. Some embodiments may include increasing the albedo to above 0.5, or further to be above 0.7.

In other applications of environmental modification, the albedo may be decreased. Decreasing albedo may reduce the reflection of sunlight and/or increase the absorption of solar energy. For example, this may be beneficial in applications where increased local evaporation rates may be desirable. This may also be beneficial in applications where increased warming may be desirable.

The ability to control evaporation may be important because blocking or suppressing evaporation by the presence of a material (such as in the floating plastic island proposal of the prior art) could unintentionally cause the temperature of the underlying ocean water to be higher than if evaporation were allowed to occur. The thermodynamic latent heat of vaporization of water is significant, and as the water is vaporized, the liquid water that remains behind may be cooled by providing at least part of the energy of vaporization to the vaporized water. Additionally, if evaporation were to be blocked over large areas of ocean, an unintended climate and weather change could undesirably occur, and rainfall patterns could be altered from these unintended potentially large effects on the earth's water cycle. However, in some other applications of environmental modification besides global warming, the evaporation rate may intentionally be reduced locally and reversibly. One application where evaporation rate may be reduced may be to reduce the severity of tropical storms.

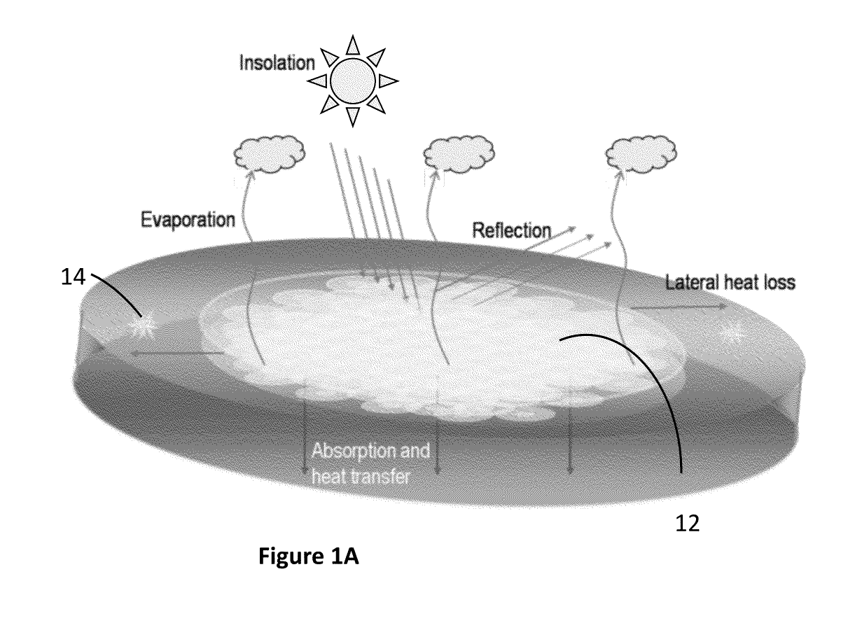

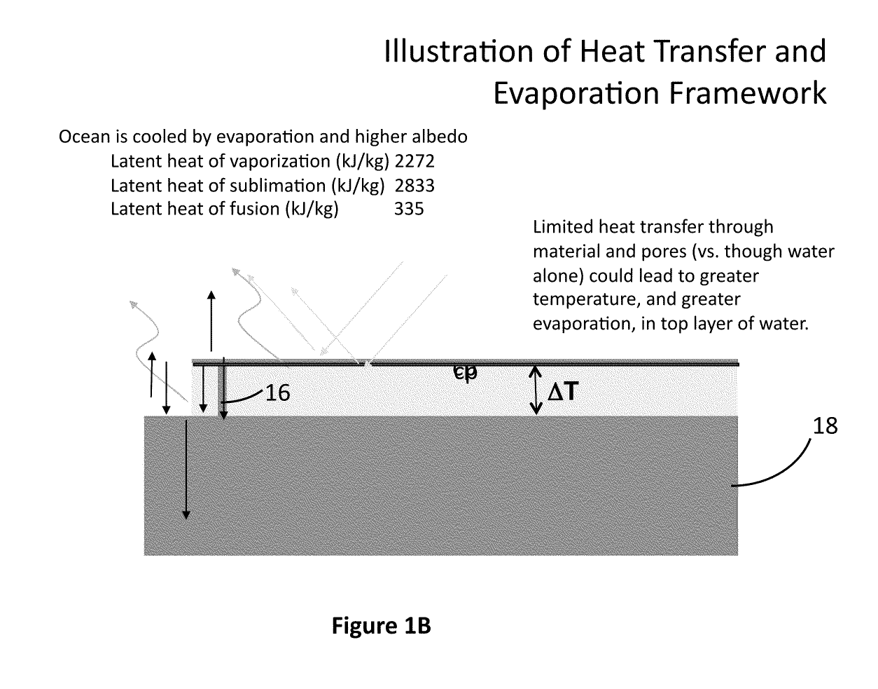

FIG. 1A illustrates one embodiment of the invention, which may incorporate a floating material 12 that may reflect sunlight and enhance water evaporation, which may allow the temperature to drop sufficiently in the exposed water to allow freezing and initial formation of ice 14. The invention may help substantially in ice retention and formation, even if deployed at a time of year when ice formation may not be expected to occur, by enhancing ice retention (slowing the melt) or reducing the heating over the summer, as well as being used at the onset of the hoped-for freezing season.

Sunlight may hit a climate control material and the surrounding water, snow, ice, permafrost, land, or man-made structures. In some embodiments of the invention, the surrounding water may include ocean water, sea water, lakes, rivers, bays, or any other natural or unnatural body of water, or may include any water of any form, such as dew or ground water, melt water, and so forth. Also within the scope of the invention is use of the climate control material on or in conjunction with underlying or surrounding glaciers, ice, snow, land areas or man-made structures.

The reflective properties of the climate control material may cause some of the sunlight to reflect away from the water surface, while part of the sunlight may be absorbed, and the energy transmitted to the surface below. The energy from the sunlight hitting the water directly may also be absorbed into the water. Part of the energy in the water, including in the water on top of, or absorbed or adsorbed on the surfaces or in the pores or openings of the climate control material, may result in evaporation of underlying and surrounding water, or of accumulated water from rainfall. Also, as water sloshes on top of climate control materials, the materials may provide a place of possible enhanced evaporation and freezing. Water may saturate some of the materials in accordance with some embodiments of the invention, and may cause different rates of evaporation. Evaporation may lead to increased cloud cover, which may affect the climate locally and globally. For instance, cloud cover may reduce the amount of sunlight that may warm the underlying area.

Several systems that may adjust the local albedo and evaporation rate may be encompassed in this invention, and may be used separately or together. Specific embodiments are not meant to limit the scope of the invention, but rather to illustrate some particularly useful embodiments of the current invention.

### A. Use of Materials for Environmental Modification

1. Material Properties

This invention provides methods of environmental modification with climate control materials and coverings by causing a local adjustment of (1) the absorption and/or reflection of incident solar energy (albedo), and (2) the rate and amount of evaporation of water. Materials may include buoyancy or floating features of the invention which may aid in the invention's effectiveness. Materials may also have various surface designs and features that may provide increased or decreased surface area, which may affect the evaporation rate of surrounding water. Heat transfer through fluids on the material surface may affect evaporation and local environment. The invention may also be designed to minimize ecological harm. The materials may also enhance ice nucleation, provide habitat and breeding ground, and may enhance cooling by evaporative heat transfer and by providing an increased area over which evaporation and over which heat transfer can occur.

Local albedo and evaporation rate may be affected by material properties of the climate control materials and coverings. A method of environmental modification may include using climate control materials with varying optical properties, wettability, buoyancy, thermal conductivity, imperviousness, strength/breaking, source of materials, and biodegradability. Climate control materials may have different designs or forms which may affect material properties. Affecting these material properties may result in affecting local albedo and evaporation characteristics, which may result in environmental modification.

For example, adjusting buoyancy or suspension height of a material may affect the local albedo or the evaporation rate of water, may enhance ice nucleation or delay ice melt, or may provide for a wildlife pullout (temporary resting place for wildlife during migration), temporary habitat, or breeding ground. The interaction of the material with the water may act to locally increase the temperature of a film of water on the materials which may affect the heat transfer for and from evaporation.

FIG. 1B shows a layered model for heat transfer and evaporation as an example of a heat transfer model. For example, limited heat transfer through coatings or pores 16 (as opposed through just water alone) may lead to greater temperature, and therefore greater evaporation in a top layer 18 of water. This may increase the evaporation rate in the top layer 18, increasing overall evaporation.

2. Material Source—Recycled Materials

In one embodiment of the invention, the climate control materials may include previously used or recycled materials. For example, the materials may comprise recycled ceramic materials, plastic bottles, or scrap plastic. Another example of a previously used material may be a fishing float, such as hollow glass fishing balls (also known colloquially as Japanese fishing floats), used traditionally to support fishing nets.

A benefit to using previously used material may be that the material cost could be low, and the environmental benefits to reusing materials. For example, if using plastic bottles, it could be of particular advantage to paint the bottles or select bottles of a required color in order to enhance their albedo. Additionally, selecting bottles that have wettable surfaces, or coating them with a thin layer of material to make them wettable, may increase the evaporation rate of surrounding or underlying water and prove to be advantageous. The previously used materials may be treated in any way to adjust the material factors discussed previously, which may affect local albedo and evaporation rate.

3. Material Source—Biodegradable Materials

In an alternate embodiment of the invention, the climate control materials may include include biological materials, such as hay or daisies. Other examples of biological materials may include straw, sawdust, paper, or wood. Such biological materials may be biodegradable. The biological material may have a coating, such as a spray plastic coating or paint, to enhance the lifetime of the material in water, maintaining its buoyancy and albedo.

In another embodiment of the invention, climate control materials may also comprise non-biological materials that may be biodegradable. For example, a sheet-like structure may be used with a biodegradable fabric.

A benefit to using biological materials may be that the materials could be inexpensive, and may have a high albedo, which may reduce the absorption of solar energy. This embodiment may be an inexpensive option available to place a high albedo material over large areas of ocean, ice, snow or glaciers.

For the successful implementation of this embodiment, a light spray coating of plastic, a suspension of the materials on netting or rafts, and the like, may assist with controlling degradation, darkening, or sink rate of the materials. Additionally, biologically active residues of these materials (such as seeds, which could possibly displace other crops if they come to shore intact) may be removed from the materials before deployment, or inactivated through sterilization or coating. Additional treatment may be necessary to prevent biological materials from having a detrimental environmental impact.

Alternatively, biological and biodegradable materials could be allowed to darken or degrade, which may allow them to be self-removable or self-reversing. Biodegradable materials may be self-removing through biodegradation or sinking, and materials whose properties (such as color) may change over time, may be self-neutralizing or self-reversing through biodegradation or other effects such biofouling or pore plugging.

Embodiments of materials, designs, and other systems for environmental climate control materials are described in PCT Application No. PCT/US08/11689 entitled “Systems for Environmental Modification with Climate Control Materials and Coverings” by Leslie A. Field, filed Oct. 9, 2008 and in corresponding U.S. application Ser. No. 12/680975 filed Nov. 11, 2010, both of which are hereby incorporated by reference herein in their entirety.

### B. Deployment

1. Where

Climate control materials and coverings may be deployed in different locations and may have different climate control applications. The albedo in a location may be increased or decreased by addition of climate control materials to areas of ocean or other bodies of water (whether floating free or tethered to shore), thin ice, glaciers, snow, or land, using materials, methods and/or systems as described in this application.

In one application, applying climate control materials to a body of water may increase the areas of ice or snow by use of some or all of the following: preventing overheating, providing cooling, providing a platform for re-formation of an ice pack, catching and retaining snow and/or precipitation, providing booms to sequester and maintain ice where wanted, defining open areas with booms, and using booms or other features to provide a platform for instrumentation powering and communication. Deployment into a body of water can also provide a platform for pullouts to provide a temporary rebuild of habitat for various species.

Applying climate control materials tethered to a shore may provide a platform for ice formation that may connect with the shore, and may allow the materials to act as a connected pullout for various living creatures.

A slightly different implementation of applying climate controls may be used for slowing down the melt of glaciers or other icy and/or snowy regions. For this purpose, the material may not be floated on the surface, but can simply be distributed or scattered on, placed on or positioned near a surface whose albedo and/or evaporation rate, is to be raised. Additionally, the materials can be placed on meltwater glacial lakes to cool them and help prevent their eventual breaking through underlying ice, which could, if unchecked, result in increased risk of lubricating the sliding off of areas of ice sheet into the ocean. In one embodiment, materials used on glaciers may be wetted on surfaces or within any pores, which may have an evaporative cooling effect. It may be beneficial to provide containment for the materials so they are not washed away or blown away, but the containment boom in such case will likely not need to be as strong or buoyant as those required in an ocean environment. Sensors, powering and communication may be very useful to track the performance of the systems so deployed.

2. How

The climate control materials and coverings may be deployed in different manners for different applications. For example, in an embodiment where materials may be deployed in a body of water, the materials may be deployed from a shore and may be taken to their desired location by currents. In such embodiments, the materials may be connected to a buoy of some type. Similarly, materials may be deployed by being set afloat from a river or from some sort of platform adjacent to the water (i.e. oil rig type structures). In these types of deployments, materials may or may not be enclosed in corrals.

Deployment of the climate control materials by helicopter, airplane, or ship or submarine may also be possible for this system. If the materials are also to be corralled and/or controlled by a containment boom, which may have sensing/powering/communication systems in place, the objects can be dropped in pre-placed containment booms in the required amount. The material may be dropped in a random manner spatially, and may achieve their own packing form under the influence of oceanic waves and wind. The material may end up probably hexagonally close packed (or a distribution of sizes even more closely or densely packed if a bimodal or multimodal size distribution is used). Open areas may be defined by interaction of amount of material used and size of containment areas.

In some embodiments, such as if the materials are more plate-like in structure, they may be dropped into place, and in some embodiments may require some on-site assembly. If the dropped materials are to be corralled, they may be dropped into pre-placed corrals. Otherwise, they might simply be dropped in the appropriate location.

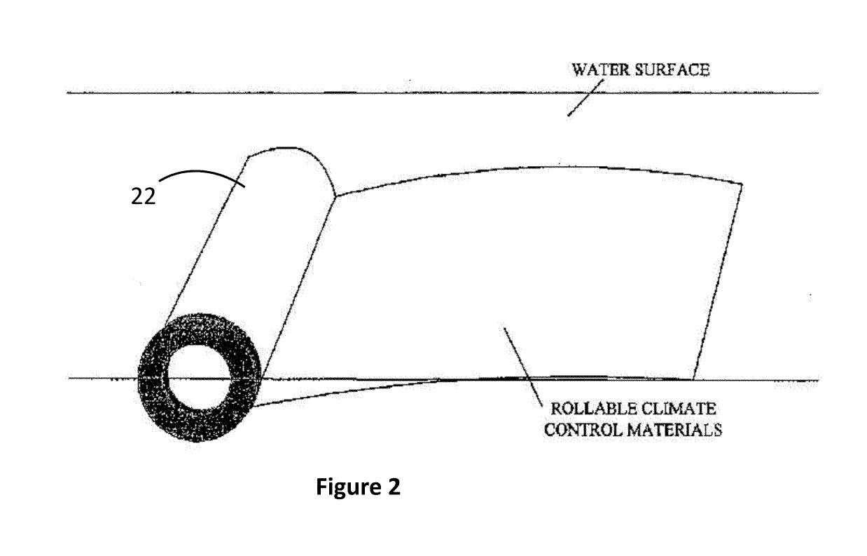

FIG. 2 illustrates how the materials may also be deployed by unrolling. For example, rather than dropping materials in the ocean, the materials may arrive in a large cylinder or roll 22, and may be unrolled to cover the desired area. This may be applicable when the materials are comprised of a sheet-like structure.

In one embodiment of the invention, the materials may be deployed without anchoring, with judicious placement of the device, material and/or system within suitable current patterns that will maintain it within potentially active ice formation for months to years. The invention may be reusable, serving to seed neighboring areas of ice similar to the action of polynyas (areas of open water surrounded by ice), or may be incorporated into growing ice. It may also serve as a platform to enhance retention without melting of snow as it falls, enhancing albedo and snow and/or ice coverage in this way as well. Ice may also be formed or enhanced from seawater sloshing up onto the surface, which may itself provide another evaporation surface.

3. Arrangement

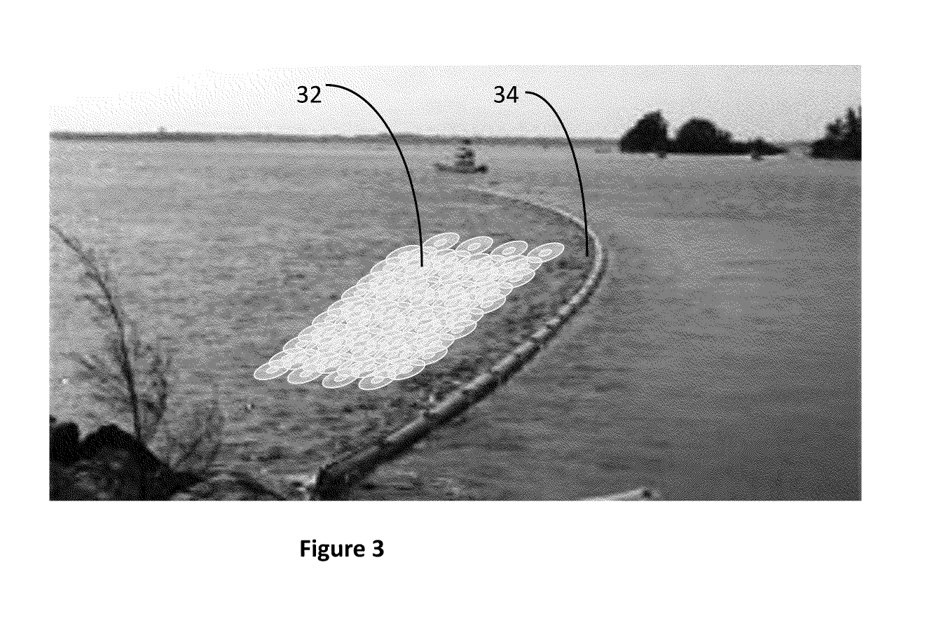

In one embodiment of the invention, the components of the climate control materials may be relatively small floatable materials, such as materials in roughly spherical shapes, bottles, or fibers or any other floatable material that may be relatively loose. Such floatable materials may be arranged in such a way so that they form a unit. For example, floatable materials may be corralled into a unit, as shown in FIG. 3. In accordance with one embodiment of the invention, materials 32 may be corralled within an enclosed or partially enclosed unit 34. Such units may be arranged or distributed in different manners to form a cluster.

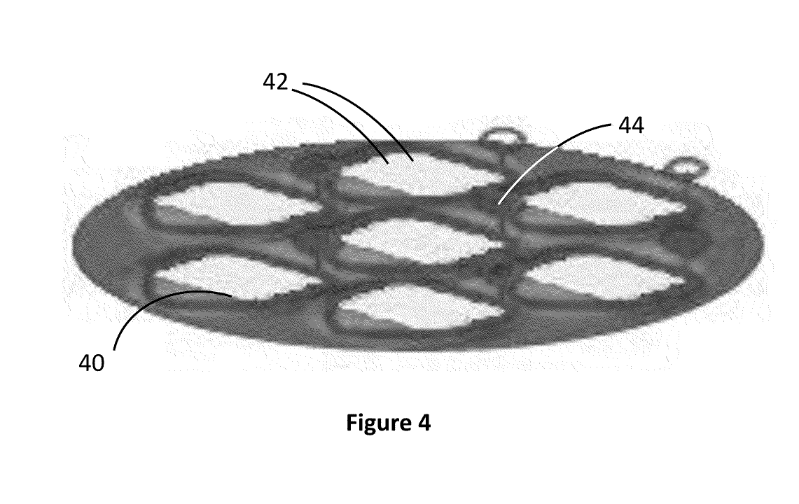

FIG. 4 shows one example of a unit cluster 40 for floatable climate control materials. Climate control materials may be corralled into building blocks 42 which may be clustered in a roughly hexagonal close packed arrangement, which may allow the effects of the deployment to be enhanced through coverage of a larger area, and through definition of accompanying open areas 44. The hexagonal close packed array can, within the scope of the invention, be further extended out to include more elements.

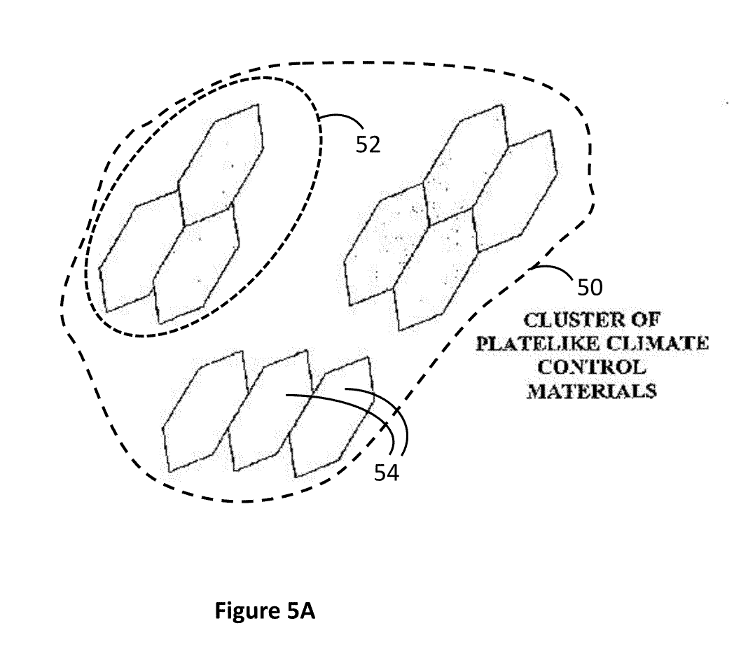

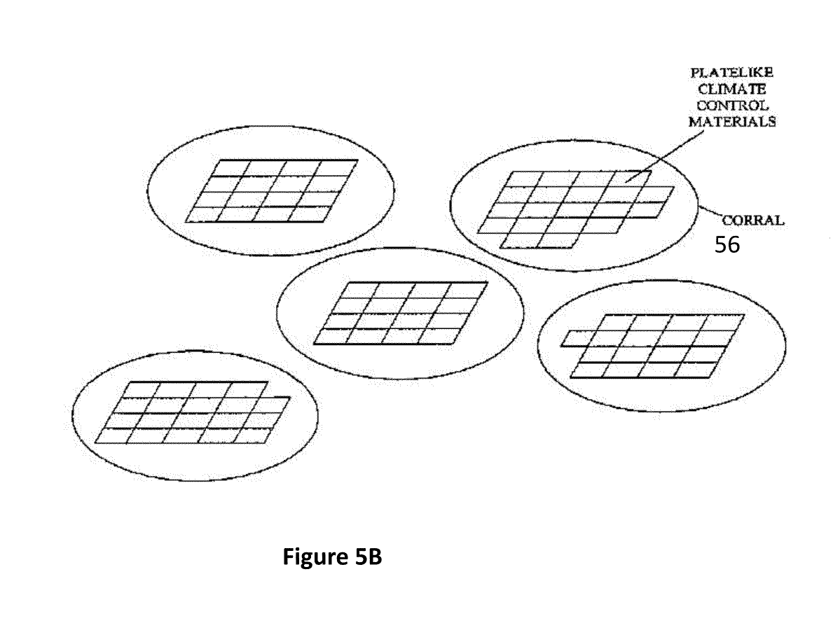

In accordance with another embodiment of the invention, FIG. 5A shows another example of a unit cluster 50 for floatable climate control materials comprising building blocks 52 made up of plates 54. The building blocks may be relatively close packed or may be more loosely packed. In some embodiments, as shown in FIG. 5B, the building blocks may be confined within corrals 56 to control location, while in other embodiments they may be free.

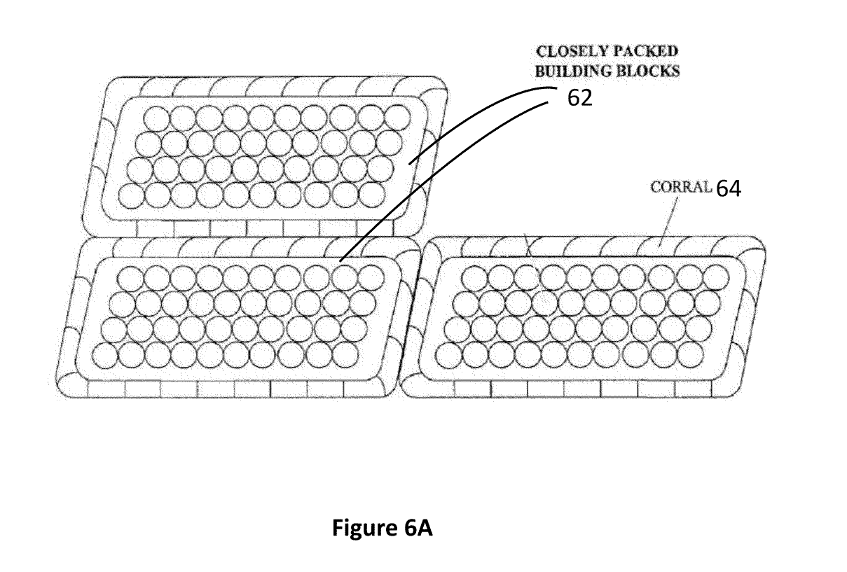

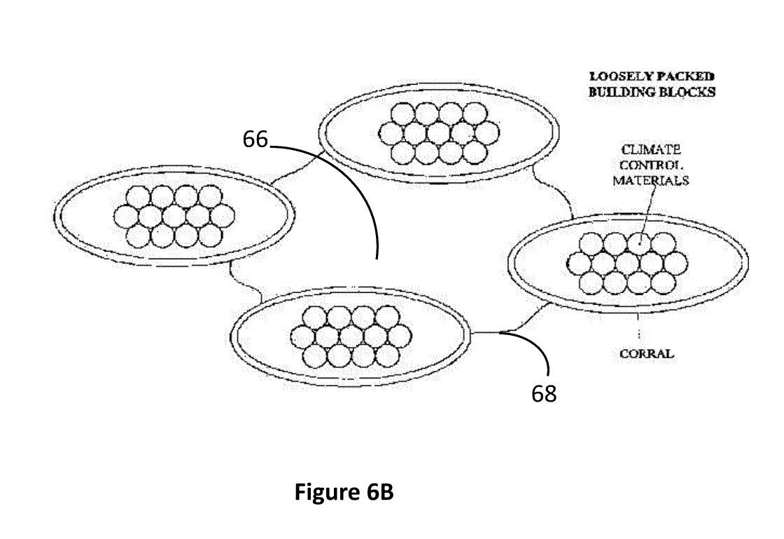

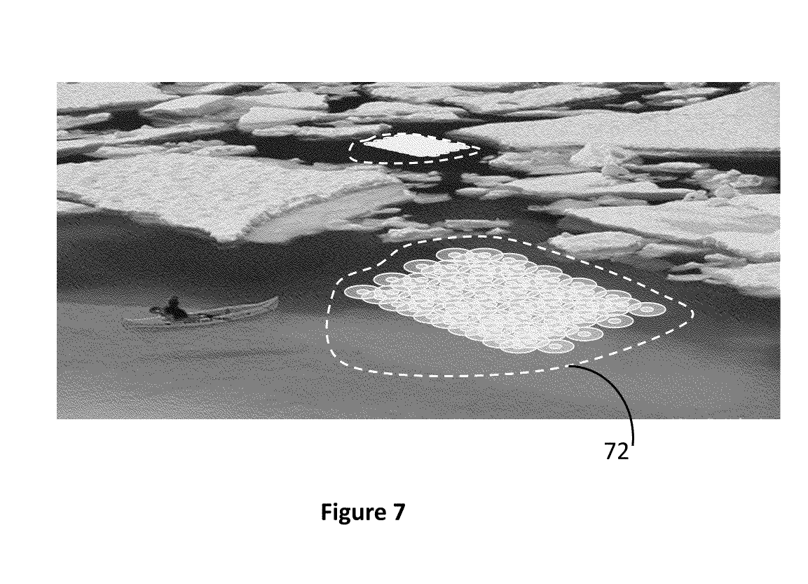

FIG. 6A shows an embodiment of the invention where the building blocks 62 may be closely packed while confined within corrals 64. FIG. 6B shows an alternate embodiment of the invention where the building blocks may be corralled but in a looser arrangement so that they there may be more open areas. The building blocks may be corralled so that they are loosely packed but connected by links 68 to keep them within some distance from one another, or may be corralled but kept separate from other corralled building blocks so that they may have the ability to break apart and roam free. FIG. 7 shows one embodiment of the invention where corralled building blocks 72 may be distributed individually and may go their own way. For example, this may result in the corralled building blocks integrating with existing ice.

The percentage of open area is designed and maintained through the combination of amount and size of the floatable objects used in a given area, and the size of the containment corral or boom. It can be advantageous to intentionally maintain such an open area to mimic the behavior of polynyas and to have open ocean areas adjacent to areas of ice formation. Such areas may enable higher evaporation and heat transfer in the polar oceans, or any other bodies of water, such as bays, lakes, rivers, and so forth. Thus the percentage and design of open area can be varied for different applications. It can also be an advantage to maintain open areas to help maintain the under-ice ecology normally present, and to allow sea creatures to surface and dive following their usual habits.

As in several of the embodiments described above, a corral or containment boom can be used to constrain the elements of the system before, as or after they self-assemble or otherwise move into position. Corrals may use submerged and/or above-water netting, that could catch the balls or any other climate control materials while allowing ice crystals to be blown out of the area. This can also serve to keep the materials, devices and system removed from shipping lanes and the like. And as in the embodiment above, sensing, powering, and communication functions can be placed in the containment boom—or in this embodiment, in or on the sheet, or in the optional central support. Signatures for sensing may be placed on the materials themselves in case they break free, such as radio-frequency identification or small sensors, such as smartdust sensors, to be discussed further below.

4. Timing

Materials may be deployed at any time. In one implementation, spring could be a favorable time to deploy materials to allow them to help defer thaw, which may increase the amount of ice retained during the warm months of the year. In another implementation, deploying materials in the fall may aid in the freezing and creation of new ice into the cold season, and may furthermore help by increasing the albedo of new ice so formed. This may allow them to defer thaw, which may increase freezing. Deploying materials in the spring or fall may also enhance or provide habitats for wildlife during breeding season.

In another implementation, materials may be added at a time so that in the summer, the materials may have a cooling effect to limit oceanic temperature rise. In the winter, or as the temperature cools, the materials may providing a cooling effect even if the materials are removed by that time, regardless of whether ice forms or not.

### C. Reversibility

A feature of the invention is that adjustments can be made locally and reversibly. Thus, for example, the adjustment may allow increased ice and/or snow coverage to be made within the arctic, antarctic or glacial regions desired, placing the effects where most needed. In another example, the adjustment may provide cooling in effects in any region. In the event that a correction of the adjustment is desired, the implementation of the invention can be modified to reverse the correction, or it can simply be removed. For example, with removal or reversal of the implementation, a greater solar-energy-absorptive area may again be available. For reversal, placement of materials at locations other than at the polar regions may be even more effective.

It may be possible to remove the systems if it is desired to return to the original climatic state or at least partially return to the original state (for instance, if the system overcorrects, or for some other purpose). In some implementations, a seasonal removal of the invention may be desired. For instance, climate control materials may be collected (and disassembled or rolled up if necessary) and taken back to shore. Climate control materials that have been collected may be reusable for the next season. In some implementations, climate control materials may also be removed in order to weather storms and may be replaced when safe to do so.

In some implementations, the ability to remove the climate control materials may not be available over the extremely long term, if an aspect of the invention is that over time it will eventually be incorporated into naturally growing areas of ice and/or snow. In fact, this invention may possibly help return the earth's ice past the “tipping point”, wherein the natural albedo of the earth's surface may be again high enough, on average, that the polar icecap and glacial melt is slowed, or even reversed.

In some instances, the material properties of climate control materials may enable the invention to self-remove. For instance, as discussed earlier, materials may be designed to sink after a given period of time or set of circumstances. Materials could also crumble or break apart over time. Climate control materials may also include biodegradable materials. For example, fabrics may be made of a biodegradable material, which may biodegrade over time, reducing initial costs and providing a built-in timed removal of the system. In another example, the materials could break after a thermal cycle such as freezing into ice, ensuring that they may sink after helping to form a season's worth of ice. For instance, freezing materials may enter an opening in the material, and cause the material to crack. In another implementation, deliberately providing a very slow leakage pathway for liquids, such as water, into a chamber that has initially provided buoyancy, such as the gas-filled core of a hollow sphere, can eventually make the material sink, removing it from the surface ecosystem after a specific period of time. In some embodiments, materials may self-remove from carbon uptake, which may have carbon sequestration applications. A material may also break apart from wear. Breaking in certain modes may be useful in rendering floating materials more likely to sink, as for instance if a pathway to the buoyant, gas-filled chamber is breached as an outer layer of material is eroded or broken away, eventually making the material sink to remove it from the surface ecosystem after a specified period of time. Furthermore, materials can also be enclosed in a container or bag designed to sink over a period of time and drag the materials down.

In some situations, instead of or in addition to removing climate control materials, it may be possible to use an additional implementation for reversal. For instance, after using climate control materials to increase ice or snow coverage, one may use climate control materials of low albedo and/or of wettability and other characteristics that enhance heating and suppress evaporation to reverse that effect.

In addition to making the invention reversible, one embodiment of the invention may be to include climate control materials that may self reverse after a period of time. For example, rather than having to collect the materials, the materials may undergo a change that changes the local albedo or evaporation rate after a period of time. For example, the material may be designed so that the albedo and/or evaporative characteristics may reflect the characteristics of the surrounding environment after a set amount of time, so that they may exert a neutral environmental influence. Alternatively, the material may be designed so that the albedo and/or evaporative characteristics have a reversing effect that is an effect much less than, or opposite to, the initial implementation, so that they may exert a reversing environmental influence.

In one implementation of the invention, the climate control materials may change properties such as albedo or evaporation over a period of time due to environmental factors such as biofouling or pore clogging. For example, a fabric-like material may change color over time due to biofouling, which may result in self-neutralizing or reversing effects.

The local and reversible nature of the invention may be essential in a control system that is a small part of a complicated, interacting planetary climate system about which much is not yet known, allowing the possibility for control and prevention of overcorrection in either direction.

### D. Environmental Modification and Other Applications

The ability to engineer some limited local environmental climate control may be useful in scenarios relating to global warming, and even in situations where another means of control for global warming have been instituted or in the absence of global warming. Possessing the capability to tailor climate locally and globally using the techniques of the current invention may have advantageous applications.

In one application of the invention, the systems may be used to rebuild polar ice. In such an application, it may be preferable for climate control materials and coverings to have high local albedo and increase local evaporation rates, as discussed previously. Other material properties and designs may be optimized for polar ice rebuild.

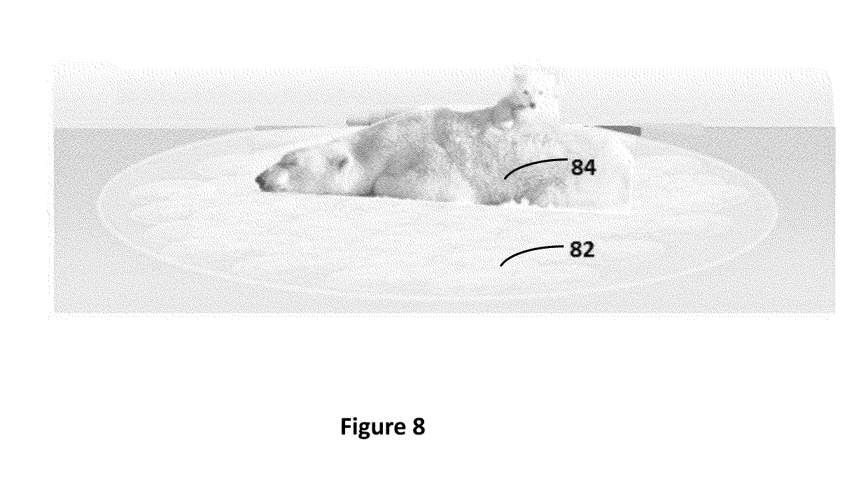

In another application of the invention, the systems may be used as an interim habitat for various species, for instance while the polar ice rebuilds. One example of this may include a pullout for polar bears, walruses, or other species, as mentioned previously. FIG. 8 illustrates an example of a pullout 82. A pullout may be a place for various wildlife 84 to rest while migrating. The systems may also be used as a temporary habitat or breeding ground. Climate control materials may provide a pullout without affecting local albedo and evaporation rates. In some embodiments, in addition to causing high local albedo and evaporation rates, the climate control materials used in these applications may have a high buoyancy and other factors to render the habitat hospitable to the wildlife being hosted.

The systems may be used for glacier retention or rebuilding in accordance with another application of the invention. Climate control materials may be scattered on glacier surfaces or open water. Such materials may have a high albedo and/or may increase local evaporation rate. Similarly, the systems can be used for snow retention and building in sensitive climate and recreational areas.

Another environmental modification application may include crop environmental modification. Climate control materials may be used for temperature and moisture control. The albedo of the materials may affect how much sunlight is reflected, which may affect local temperature. Furthermore, the local evaporation rate can be adjusted as desired.

In another application, by properly controlling the rate of evaporation over bodies of water, the invention can be used at the proper time of the year to diminish the intensity of tropical storms, and removed following the storm season to allow normal evaporation levels. In this application, a device, system or method may be used to adjust the albedo and the evaporation characteristics of areas in order to decrease evaporation, to in turn decrease rainfall and/or storm severity. In addition, the invention may be used for adjustment of the relative humidity of areas surrounding the adjusted areas in order to decrease evaporation to decrease rainfall and/or storm severity. Aspects of the invention may be adjusted as discussed previously, with characteristics tailored to reduce evaporation.

One preferable embodiment of the invention that may be applied to the storm control aspect of the invention may be to use a monolayer coating of a liquid (akin to “pouring oil on troubled waters”) that may reduce the evaporation rate of the water in the storm path. The effect of the fluid coating may be temporary, and it may be removed, either by dispersal, biodegradation, or by being consumed by wildlife or other environmental actions or agents. Such a fluid coating may be chosen to have a small or zero ecological impact, and may advantageously include materials such as mineral oils or vegetable oils (including com oil, given current high production levels of com).

A plastic sheet, preferably without pores, or rafts of plastic bottles as described previously, but chosen or treated so as to be largely unwettable may also be examples of advantageous embodiments of this invention for a storm control application. Such materials may also provide a form of cover that may reduce evaporation, thereby diminishing the intensity of storms. Materials such as plastic sheets may be particularly effective since they may be deployed easily, through means such as unrolling, and undeployed easily, through means such as rolling them back up when a storm is over.

This invention may be applied to rainfall pattern modification as well. By properly controlling the rate of evaporation over bodies of water, the invention can be used to enhance evaporation to increase rainfall and/or alleviate conditions of drought. In this application of the invention, a climate control material may adjust the albedo or relative humidity of areas in order to enhance evaporation to increase rainfall and/or alleviate drought. The system may be removable when no longer needed, to allow the area to return to its normal weather pattern.

This invention may also be used in applications requiring increased efficiency of cooling, such as for industrial applications such as power plants and large data centers, especially in regions where excess heat has an adverse environmental impact.

Furthermore, this invention can be used to stabilize permafrost, with a possible side benefit of preventing release of methane (a powerful greenhouse gas) and a benefit of stabilizing infrastructure used for housing, roads, pipelines, utilities and the like.

The techniques of this invention can be further used to contribute environmental control to man-made structures and buildings, introducing a cooling element to such facilities.

In a further application, the techniques of this invention can be used in conjunction with judicious choices of composition and structure to enhance carbon sequestration from the atmosphere and the ocean by incorporating more stable reactants, such as calcium and magnesium carbonate compounds, into the environmental modification materials over time.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A method comprising:
deploying a material having an albedo of at least 0.15 over a surface of a body of water associated with a man-made structure, such that the deployed material increases an albedo of the surface, increases an evaporation rate at the surface for a given temperature, and decreases a temperature characterizing the man-made structure.

2. The method of claim 1 wherein the man-made structure is one of a power plant and a data center.

3. The method of claim 2 wherein the material is characterized by a wettable surface that provides a large effective surface area relative to the surface area of water covered by the material.

4. The method of claim 3 wherein the material surface includes one or more wettable pores.

5. The method of claim 1 wherein the material comprises a plurality of hollow components.

6. The method of claim 1 wherein the material removes itself from the water surface by at least one of the following mechanisms: sinking, bio-degrading, breaking up, and dispersing.

7. The method of claim 1 further comprising monitoring the position of the material after the deployment.

8. The method of claim 1 wherein the deployed material has a coating that modifies at least one of the following: the material's albedo, the material's buoyancy, the material's degradation rate, and the evaporation rate in the local area following deployment of the material.

9. The method of claim 1 additionally comprising removing the deployed material from the water surface after a desired time period from the start of the deployment.

10. A method comprising:
deploying a material having an albedo of at least 0.15 over ground surrounding or underlying man-made infrastructure such that the deployed material increases an albedo of the ground surface, increases an evaporation rate at the ground surface for a given temperature, and decreases a temperature characterizing the ground surface.

11. The method of claim 10 wherein the man-made infrastructure includes at least one of housing, industrial and public-use buildings and equipment, roads, and pipelines.

12. The method of claim 10 wherein the ground includes at least one of ice, snow or permafrost.

13. The method of claim 10 wherein the material is characterized by a wettable surface that provides a large effective surface area relative to the surface area of ground covered by the material.

14. The method of claim 10 further comprising sensing and communicating data regarding at least one of the environmental impact and the ecological impact of the deployed material after deployment.

15. The method of claim 10 additionally comprising removing the deployed material from the ground after a desired time period from the start of the deployment.

16. A method comprising:
deploying a material having an albedo of at least 0.15 over a surface of a body of water such that the deployed material increases an albedo of the surface, increases an evaporation rate at the surface for a given temperature, and decreases a temperature characterizing the body of water;
wherein the material is characterized by a wettable surface that provides a large effective surface area relative to the surface area of water covered by the material.

17. The method of claim 16 additionally comprising removing the deployed material from the water surface after a desired time period from the start of the deployment.

18. The method of claim 16 wherein the material removes itself from the water surface by at least one of the following mechanisms: sinking, bio-degrading, breaking up, and dispersing.
